(19) United States
(12) Patent Application Publication
(10) Pub. No.: US 2019/0050789 A1
(43) Pub. Date: Feb. 14, 2019

(54) METHOD OF DELIVERING PRODUCTS USING AN UNMANNED DELIVERY EQUIPMENT

(71) Applicant: Hyun Sung KO, Seoul (KR)

(72) Inventor: Hyun Sung KO, Seoul (KR)

(21) Appl. No.: 15/780,001

(22) PCT Filed: Oct. 20, 2016
(86) PCT No.: PCT/KR2016/011844

§ 371 Date: May 30, 2018

(30) Foreign Application Priority Data
Oct. 28, 2015 (KR) 10-2015-0150333

(51) Int. Cl. G06Q 10/08; B64C 39/02

(52) U.S. Cl. CPC G06Q 10/083; B64C 2201/128; B64C 39/024

(57) ABSTRACT

A method for delivering a product, performed by an unmanned delivery device, is provided. The method may comprise the steps of: acquiring information on the delivery destination of the product, a departure station, a destination station, and a transportation means for carrying the unmanned delivery device at the departure station; controlling the unmanned delivery device such that the same is driven to the departure station; checking whether the transportation means has arrived at the departure station; when it is determined that the transportation means has arrived at the departure station, loading the unmanned delivery device in the transportation means; checking whether the unmanned delivery device has arrived at the destination station; and when it is determined that the unmanned delivery device has arrived at the destination station, controlling the unmanned delivery device such that the same is driven to the delivery destination.

### BACKGROUND

### 1. Field

Exemplary embodiments of the present inventive concept relate to a method of delivering products. More particularly, exemplary embodiments of the present inventive concept relate to a method of delivering products using an unmanned delivery equipment.

### 2. Description of the Related Art

Electronic commerce to sell products have been generalized. Most sellers are using a post office parcel delivery service, a post office home delivery service and a quick delivery service as a product delivery method. However, in the above product delivery method, a lot of manpower and much cost are consumed and not little delivering time is consumed because of a complicated delivering process. In addition, in the above product delivery method, there is danger of accident of a deliverer, natural resources are necessarily used and air pollution is generated. To prevent the above mentioned disadvantages, recently, a research for a method of delivering products using an unmanned delivery equipment such as a drone is being carried out. The drone is one of an unmanned aerial vehicle (UAV) and developed for a military purpose. Utility of the drone is expanding so that the drone is being used in various fields such as broadcast shooting, reconnaissance, observation for public security and so on. Furthermore, the utility of the drone may expand to product delivery. In the United States, the drone is limitedly allowed for the product delivery by a law. Amazon is planning to deliver a small parcel less than five pounds in a short distance in ten or twenty kilometers as a name of Amazon Prime Air.

However, when the products are delivered by the drone, following problems may be generated: the drones may be collided with each other in the air, the drone may be crashed due to mechanical defects or barriers such as electric wires so that the drone may be damaged and a person in a street may get hurt, and the drone may be stolen. When the drone is operated, a battery is consumed so that the drone may not deliver the product in a long distance. Thus, the method of delivering products using the unmanned delivery equipment is required to be enhanced.

### SUMMARY

Exemplary embodiments of the present inventive concept provide a method of delivering products using an unmanned delivery equipment capable of minimizing flying time, reducing danger of crash of the unmanned delivery equipment and minimizing battery consumption by minimizing flying distance of the unmanned delivery equipment.

The purpose of the present inventive concept may not limited the above mentioned purpose. The purpose of the present inventive concept not mentioned above will become more apparent by following descriptions.

According to the exemplary embodiments of the present inventive concept, in the method of delivering products using the unmanned delivery equipment, the flying distance may be minimized, the danger of the crash of the unmanned delivery equipment may be reduced and the battery consumption of the unmanned delivery equipment may be minimized.

### BRIEF DESCRIPTION OF THE DRAWINGS

The above and other features and advantages of the present inventive concept will become more apparent by describing in detailed exemplary embodiments thereof with reference to the accompanying drawings, in which:

FIG. 1 is a perspective view illustrating an unmanned delivery equipment according to an exemplary embodiment of the present inventive concept.

FIG. 2 is a block diagram illustrating an electronic module included in an electronic component receiver of FIG. 1.

FIG. 3 is a flowchart illustrating a method of delivering products by an unmanned delivery equipment according to an exemplary embodiment of the present inventive concept.

### DETAILED DESCRIPTION

The present inventive concept now will be described more fully hereinafter with reference to the accompanying drawings, in which exemplary embodiments of the present invention are shown. The present inventive concept may, however, be embodied in many different forms and should not be construed as limited to the exemplary embodiments set forth herein.

Rather, these exemplary embodiments are provided so that this disclosure will be thorough and complete, and will fully convey the scope of the present invention to those skilled in the art. Like reference numerals refer to like elements throughout.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular exemplary embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the inventive concept as used herein.

Hereinafter, the present inventive concept will be explained in detail with reference to the accompanying drawings.

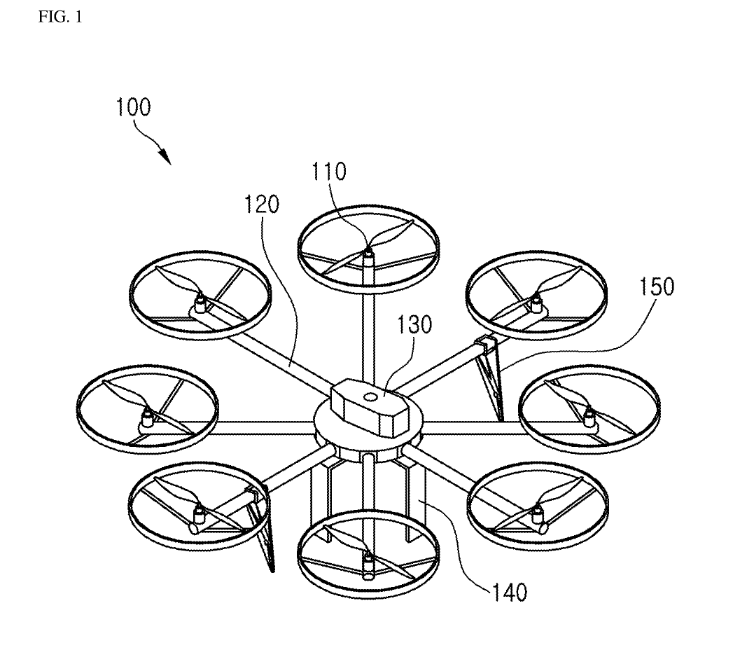

FIG. 1 is a perspective view illustrating an unmanned delivery equipment 100 according to an exemplary embodiment of the present inventive concept.

In the present detailed description, the unmanned delivery equipment 100 is referred as a drone. The drone means an unmanned aerial vehicle so that a person does not board the drone. Although, for example, the unmanned delivery equipment 100 may include fixed wing type unmanned aerial vehicles, rovers, walking robots and a hovercraft, the present inventive concept is not limited thereto. FIG. 1 does not illustrate all of mechanical elements of the unmanned delivery equipment 100 and does not illustrate all of essential elements so that the unmanned delivery equipment 100 may include additional elements than the elements of the unmanned delivery equipment 100 illustrated in FIG. 1 or may not include some of the elements of the unmanned delivery equipment 100 illustrated in FIG. 1.

Referring to FIG. 1, the unmanned delivery equipment 100 may include rotors 110, tie rods 120, an electronic component receiver 130, a lower frame 140 and a landing gear 150. The rotors 110 may provide lift force for operating the unmanned delivery equipment 100. Although the unmanned delivery equipment 100 in FIG. 1 includes eight rotors, the present inventive concept is not limited to the number of the rotors 110. The number of the rotors 110 may be varied according to conditions such as the required lift force and flying time. The tie rods 120 may connect rotors 110 to each other. For example, the tie rods 120 may be lightweight carbon fiber rods. The electronic component receiver 130 may be a housing proper to receive an electronic module including electronic components. In an exemplary embodiment, the electronic components received in the electronic component receiver 130 may be fixed by the electronic component receiver 130 and may be grounded. In an exemplary embodiment, the electronic components may be surrounded by a fire resistant foam or loaded on a rubberized brackets so that effect of vibration to the electronic components may be reduced. The electronic component receiver 130 may include a heat sink, a fan or a vent for cooling the electronic components. The lower frame 140 may support the drone 100. Although not shown in FIG. 1, a mechanical device may be formed under the lower frame 140 to fix a product to deliver to the lower frame 140. The landing gear 150 may land the drone 100 on a flat surface safely and absorbs shock generated during landing.

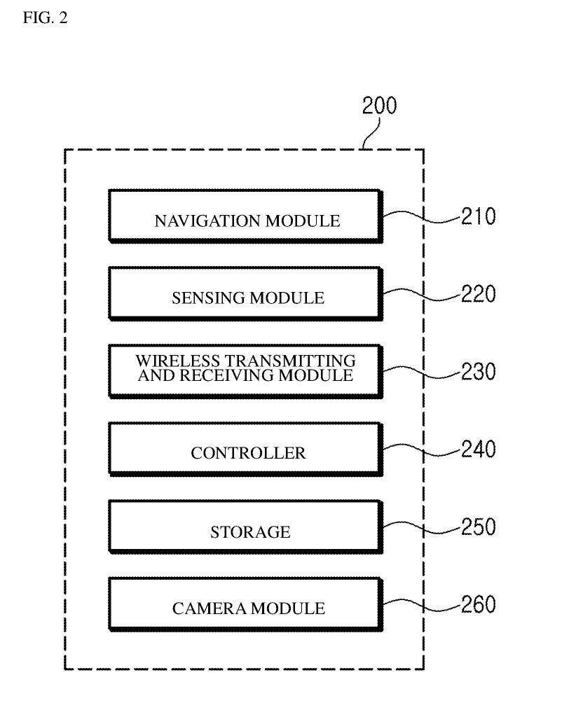

FIG. 2 is a block diagram illustrating the electronic module 200 included in the electronic component receiver 130 of FIG. 1.

Referring to FIG. 2, the electronic module 200 may include a navigation module 210, a sensing module 220, a wireless transmitting and receiving module 230, a controller 240, a storage 250 and a camera module 260. A battery (not shown) may provide electric power to the navigation module 210, the sensing module 220, the wireless transmitting and receiving module 230, the controller 240, the storage 250 and the camera module 260 to operate the navigation module 210, the sensing module 220, the wireless transmitting and receiving module 230, the controller 240, the storage 250 and the camera module 260. The battery may be charged by an external charger through a wire or wirelessly. Alternatively, the battery may be charged by solar energy (solar heat or sunlight). When the battery is charged by the solar energy, the unmanned delivery equipment 100 may include a solar cell. The navigation module 210 may determine a position of the unmanned delivery equipment 100 and may guide the unmanned delivery equipment 100 to fly to a destination. The navigation module 210 may be a receiver receiving position information and determining the position of the unmanned delivery equipment 100 based on the received position information. For example, the navigation module 210 may include a GPS receiver receiving a GPS position signal from a GPS satellite. The GPS receiver may continuously determine the position of the unmanned delivery equipment 100 based on the GPS position signal received by the GPS receiver. In an exemplary embodiment, the navigation module 210 may determine the current position of the unmanned delivery equipment 100 using both the GPS position information and WiFi position information.

In an exemplary embodiment, the navigation module 210 may determine the position of the unmanned delivery equipment 100 by WiFi triangulation method. In an exemplary embodiment, the navigation module 210 may compare intensities of signals from one or more WiFi access points. The intensity of the signal may represent a distance between the unmanned delivery equipment 100 and WiFi access point. When the positions of the plural WiFi access points are known, the navigation module 210 may determine the position of the unmanned delivery equipment 100 by the WiFi triangulation method based on only the WiFi signals. In an exemplary embodiment, the navigation module 210 may receive RFID position information from the sensing module 220. In this case, the navigation module 210 may determine the position of the unmanned delivery equipment 100 by triangulation method using the GPS position signal, the RFID position information and WiFi position data.

In an exemplary embodiment, the navigation module 210 may calculate the current position of the unmanned delivery equipment 100 using RFID tag positioning, network environment, pre-installed fast response code tag or another sensing media. In an exemplary embodiment, the navigation module 210 may determine the position of the unmanned delivery equipment 100 using RTLS (real time location service) based on RFID, WiFi, Zigbee and so on. In an exemplary embodiment, the navigation module 210 may determine the position of the unmanned delivery equipment 100 using a Bluetooth signal.

In various environments, the navigation module 210 may receive navigation route information stored in the storage 250 or provided from the wireless transmitting and receiving module 230. In an exemplary embodiment, the navigation module 210 may receive an address of start point of delivery of the product and an address of destination of the delivery of the product. In an exemplary embodiment, the navigation module 210 may further receive an address of a start station of the delivery of the product. In various environments, the navigation module 210 may provide information to a drone control person controlling the unmanned delivery equipment 100 through the wireless transmitting and receiving module 230. The navigation module 210 may operate the unmanned delivery equipment 100 along a flying route using flight route information provided from the wireless transmitting and receiving module 230. The navigation module 210 may provide data to a delivery server (not shown) which is a computing system so that the delivery server may control the rotors 110 of the unmanned delivery equipment 100 to control movement of the unmanned delivery equipment 100 along the flying route.

The sensing module 220 may include at least one sensing device selected according to power consumption. The sensing module 220 may include a high speed RFID (radio frequency identification) reader. In various exemplary embodiments, the RFID reader may read various kinds of RFID tags. For example, the RFID reader may support Ultralight, NTAG203, MIFARE™ Mini, MIFARE™ Classing 1K, MIFARE™ Classic 4K and FM11RF08. In addition, the RFID reader may read EPC (electronic product code) tag classes such as an EPC Class 0 or 1. The controller 240 may control a velocity of the unmanned delivery equipment 100 for the sensing module 220 to accurately read the RFID tag when the unmanned delivery equipment 100 is flying. If the RFID reader is used, the tag may be sensed in an adjustable range within a radius of 0.5 m to 12 m. The RFID tag may include a RFID compatibility tag. The RFID tag may be a passive RFID tag or an active RFID tag. The sensing module 220 may read the RFID tag attached to means of transportation using the RFID reader. In an exemplary embodiment, the tag information read by the sensing module 220 may be transmitted to the delivery server through the wireless transmitting and receiving module 230 under control of the controller 240. In an exemplary embodiment, the sensing module 220 may further include a QR (quick response) code reader.

The wireless transmitting and receiving module 230 may be a wireless communication device based on a wireless network protocol of IEEE 802.11. Alternatively, the wireless transmitting and receiving module 230 may be a wireless communication device based on other protocols. For example, the protocol may be selected considering the power consumption of the wireless transmitting and receiving module 230. In various exemplary embodiments, the protocols of IEEE 802.11a, b, g, n or ac may be used. The wireless transmitting and receiving module 230 may operate a handoff process. For example, the wireless transmitting and receiving module 230 may be configured to operate a high speed handoff process using 100 ms client based turbo roaming. Thus, the wireless transmitting and receiving module 230 may be configured to communicate with the plurality of the wireless access points during flight of the unmanned delivery equipment 100. The wireless transmitting and receiving module 230 may use a security protocol such as WEP, WPA, WPA2 and 802.11X to secure the wireless communication. The wireless transmitting and receiving module 230 may further receive flight route information. In various exemplary embodiments, the flight route information may be transmitted as continuous stream, and the flight route information may be transmitted from the navigation module 210 for the flight of the unmanned delivery equipment 100. The flight route information may be generated in the unmanned delivery equipment 100 or the flight route information may be provided from an operator of the unmanned delivery equipment 100. The flight route information may include the position information in a form of coordinates. The flight route information may include an altitude, an orientation and a velocity of the unmanned delivery equipment 100.

The controller 240 is connected to the navigation module 210, the sensing module 220 and the wireless transmitting and receiving module 230. The controller 240 may be configured to execute various computer programs and control the operations of the various computer programs. The controller 240 may be configured to receive data from an element and operate data formatting the data to be proper to another element. The controller 240 may be connected to the storage 250 in a way of communicating with each other. In various exemplary embodiments, the controller 240 may be integrally formed with another element such as the navigation module 210.

The controller 240 may include various computer programs to control the navigation module 210, the sensing module 220 and the wireless transmitting and receiving module 230 such that the unmanned delivery equipment 100 operates as an unmanned service drone for delivering products. The controller 240 may control the navigation module 210 to receive the address of the start station so that the unmanned delivery equipment 100 may be controlled to fly to the start station. The controller 240 may continuously shoot an object which is one of ID, QR code and an identification mark displayed at the start station and/or a transit station by the camera module 260 to displace the unmanned delivery equipment 100 toward the object. In addition, the controller 240 may determine whether the unmanned delivery equipment 100 is disposed in a predetermined distance from the object and control the unmanned delivery equipment 100 to land at the station displaying the object.

The controller 240 may operate the sensing module 220 to determine whether the means of transportation arrives at the start station and/or the transit station. The controller 240 may receive the wireless signal through the wireless transmitting and receiving module 230 from an arriving time providing server (not shown) to determine whether the means of transportation arrives at the start station, the transit station and/or a destination station. The controller 240 may control the rotors 110 such that the unmanned delivery equipment 100 to ride in the means of transportation. In an exemplary embodiment, the controller 240 may continuously shoot an identification mark displayed at the means of transportation by the camera module 260 to displace the unmanned delivery equipment 100 toward the identification mark. In addition, the controller 240 may determine whether the unmanned delivery equipment 100 is disposed in a predetermined distance from the identification mark and control the unmanned delivery equipment 100 to land at the means of transportation displaying the identification mark. When the controller 240 determines that the unmanned delivery equipment 100 is arrived at the destination station, the controller 240 may operate the navigation module 210 and control the rotors 110 to fly the unmanned delivery equipment 100 to the destination of the delivery of the product.

The storage 250 may store the computer programs or commands executed by the controller 240. In various exemplary embodiments, the storage 250 may store the flight route information in an operation environment. Herein, the flight route information may include a predetermined flight route, a landing station and a restricted area. In addition, the flight route information may include the destination of the delivery of the product, the start station, the destination station, at least one transit station, the means of transportation riding at the start station and the means of transportation riding at the at least one transit station. In various exemplary embodiments, the storage 250 may store the control information and data provided from the delivery server and the arriving time providing server. In various exemplary embodiments, for example, the storage 250 may store data read by the sensor included in the drone 100 such as the sensing module 220 and the camera module 260.

The storage 250 may include one of a flash memory type memory, a hard disk type memory, a multimedia card (MMC), a card type memory (e.g. SD (secure digital) card or XD (eXtreme Digital) card), RAM (Random Access Memory), SRAM (Static Random Access Memory), ROM (Read-Only Memory), EEPROM (Electrically Erasable Programmable Read-Only Memory), PROM (Programmable Read-Only Memory), a magnetic memory, a magnetic disk and an optical disk. However, the storage 250 may not be limited thereto.

The camera module 260 may have proper functions for high speed shooting in the air. The camera module 260 may have functions of a digital camera capable of shooting a static image and/or a video image. In an exemplary embodiment, the camera module 260 may include a plurality of cameras disposed toward various directions and rotatable in an upper direction, a lower direction, a left direction and a right direction in a predetermined angle. In an exemplary embodiment, the camera module 260 may include software to perform an image process for the recorded image. In an exemplary embodiment, the camera module 260 may include hardware and/or software to trace an object which is static or moving in the recorded image. The software for the camera module 260 may be installed in the controller 240 and integrated in the computer program of the controller 240.

In an exemplary embodiment, the camera module 260 may have an image compression function to compress the static image in a format one of JPEG (Joint Photographic Experts Group) format, GIF (Graphics Interchange Format) format, PNG (Portable Network Graphics) format. The camera module 260 may have a function to compress the video image in a video compression format one of MPEG (Motion Picture Experts Group) format, AVI (Audio Visual Interleaved) format, MOV (Quicktime) format and so on. In an exemplary embodiment, the image data (including the image processed data and the compressed data) obtained by the camera module 260 may be transmitted to the delivery server through the wireless transmitting and receiving module 230 under control of the controller 240.

The above explained exemplary embodiment may be implemented in a hardware aspect using at least one of application specific integrated circuits (ASICs), digital signal processors (DSPs), digital signal processing devices (DSPDs), programmable logic devices (PLDs), field-programmable gate arrays (FPGAs), processors, controllers, micro-controllers and microprocessors.

The exemplary embodiments including processes, steps and functions may be implemented by a firmware/software module executable on a hardware platform and operating at least one function or operation. In this case, the firmware/software module may be implemented by a software application written in a proper program language.

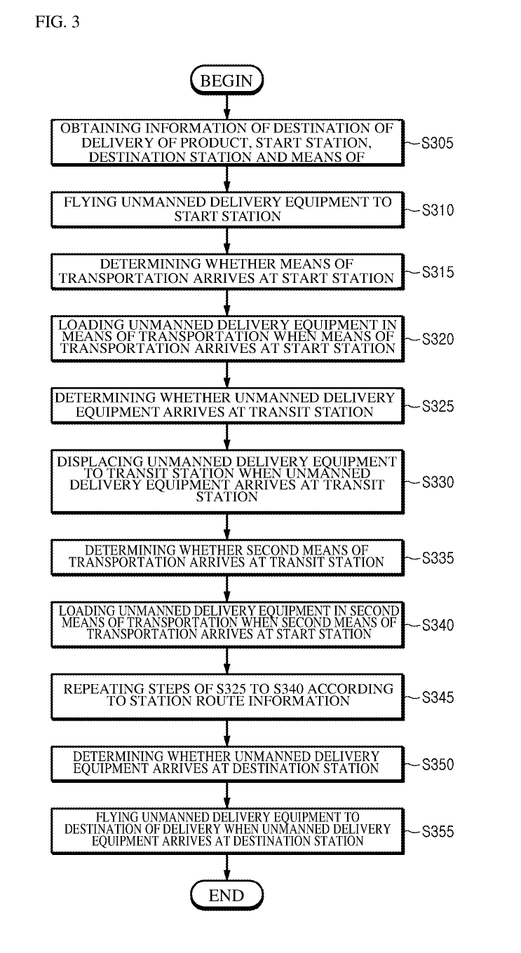

FIG. 3 is a flowchart illustrating a method of delivering products by the unmanned delivery equipment 100 according to an exemplary embodiment of the present inventive concept.

The method of the present inventive concept starts from a step 5305 of obtaining information of the destination of the delivery of the product, the start station, the destination station and the means of transportation riding at the start station by the unmanned delivery equipment 100. In an exemplary embodiment, the information of the destination of the delivery of the product, the start station, the destination station and the means of transportation riding at the start station may be received from the destination server. For example, the destination server may generate station route information based on the address of the start point which may be the address of the delivery server and the address of destination of the delivery and obtain the address, the code or the ID of the start station, the address, the code or the ID of the destination station and at least one means of transportation riding at the start station using a software for the destination server. The means of transportation may include public transportation, a private means of transportation for the unmanned delivery equipment, a freight car, a ship and an unmanned means of transportation/an unmanned equipment such as an unmanned car, an unmanned bus, an unmanned truck, an unmanned subway car and so on. However, the present inventive concept is not limited to the above mentioned means of transportation. Although the information of the means of transportation may include the ID, QR code, a number, a route of the means of transportation, the present inventive concept is not limited thereto. Although the start station may include a bus station, a private station of the unmanned delivery equipment, a station of the freight car, a station of the ship close to the address of the start point, the present inventive concept is not limited thereto. In an exemplary embodiment, the unmanned delivery equipment 100 may generate the station route information based on the address of the start point and the address of destination of the delivery and obtain the address of the start station, the address of the destination station and the information of the means of transportation using a software same as the software for the destination server.

In the present step, information of at least one transit station where the unmanned delivery equipment 100 gets off the means of transportation and waits for another means of transportation and second, third, fourth, . . . means of transportation riding at at least one transit station may be selectively further obtained. Although the information of at least one transit station may include an address, a code or ID of the transit station in an exemplary embodiment, the present inventive concept is not limited thereto. Although the information of the second, third, fourth, . . . means of transportation may include the ID, QR code, a number, a route, the present inventive concept is not limited thereto. The information of at least one transit station and second, third, fourth, . . . means of transportation riding at at least one transit station may be generated by the delivery server and inputted to the unmanned delivery equipment 100 or may be generated by the unmanned delivery equipment 100 as explained above. The second, third, fourth, . . . means of transportation may include the public transportation, the private means of transportation for the unmanned delivery equipment, the freight car, the ship and an the manned means of transportation/the unmanned equipment such as the unmanned car, the unmanned bus, the unmanned truck, the unmanned subway car and so on. However, the present inventive concept is not limited to the above mentioned means of transportation.

In a step of S310, the navigation module 210 is operated and the rotors 110 are controlled to control the unmanned delivery equipment 100 to fly to the start station. For example, the address of the start station may be set as a destination in the navigation module 210 so that the unmanned delivery equipment 100 may automatically fly to the start station. When the navigation module 210 notice that the unmanned delivery equipment 100 is arrived at a position designated by the address of the start station, the unmanned delivery equipment 100 may continuously shoot an object which is one of ID, QR code and an identification mark displayed at the start station by the camera module 260 to displace the unmanned delivery equipment 100 toward the object. The unmanned delivery equipment 100 determines whether the unmanned delivery equipment 100 is disposed in a predetermined distance from the object. When the unmanned delivery equipment 100 is disposed in the predetermined distance from the object, the unmanned delivery equipment 100 may land at the start station adjacent to the object.

In a step of S315, it is determined whether the means of transportation arrives at the start station. The unmanned delivery equipment 100 may wirelessly receive a signal notifying that the means of transportation arrives at the start station so that the unmanned delivery equipment 100 may determine that the means of transportation arrives at the start station. However, the method of determining the arrival of the means of transportation is not limited thereto. For example, the unmanned delivery equipment 100 may continuously monitor a status of the start station by the camera module 260 and identify the ID or the QR code of the means of transportation to determine the arrival of the means of transportation. In this case, the RFID reader of the unmanned delivery equipment 100 may read the RFID tag and the unmanned delivery equipment 100 may compare the information of the RFID tag to the ID of the means of transportation to identify the ID of the means of transportation.

In a step of S320, when it is determined that the means of transportation arrives at the start station in the step of S315, the unmanned delivery equipment 100 is loaded in the means of transportation. In the present step, an identification mark displayed at the means of transportation is continuously shot to displace the unmanned delivery equipment 100 toward the identification mark, it is determined whether the unmanned delivery equipment 100 is disposed in a predetermined distance from the identification mark and the unmanned delivery equipment 100 is landed at the means of transportation displaying the identification mark when the unmanned delivery equipment 100 is disposed in the predetermined distance from the identification mark. Although, herein, the identification mark displayed at the means of transportation may include the number of the means of transportation, QR code, special characters or the code, the present inventive concept is not limited thereto.

In a step of S325, it is determined whether the unmanned delivery equipment 100 arrives at the transit station. In an exemplary embodiment, the unmanned delivery equipment 100 may wireles sly receive a signal notifying that the unmanned delivery equipment 100 arrives at the transit station from the arriving time providing server so that the unmanned delivery equipment 100 may determine that the unmanned delivery equipment 100 arrives at the transit station. In a step of S330, when it is determined that the unmanned delivery equipment 100 arrives at the transit station in the step of S325, the unmanned delivery equipment 100 may displace to the transit station and may land at the transit station. In the present step, similarly to the step of S310, the unmanned delivery equipment 100 may continuously shoot an object which is one of ID, QR code and an identification mark displayed at the transit station to displace the unmanned delivery equipment 100 toward the object. The unmanned delivery equipment 100 determines whether the unmanned delivery equipment 100 is disposed in a predetermined distance from the object. When the unmanned delivery equipment 100 is disposed in the predetermined distance from the object, the unmanned delivery equipment 100 may land at the transit station adjacent to the object. In an exemplary embodiment, when the unmanned delivery equipment 100 arrives at the transit station, the unmanned delivery equipment 100 may be fixed at a position (e.g. the landed position) in the transit station so that the unmanned delivery equipment 100 may maintain a stable waiting status at the transit station.

In an exemplary embodiment, when the unmanned delivery equipment 100 arrives at the transit station, the unmanned delivery equipment 100 may be controlled such that a power jack of the unmanned delivery equipment 100 is connected to a socket or a jack of a charger disposed in the transit station to charge a battery (not shown) of the unmanned delivery equipment 100. Although the battery of the unmanned delivery equipment 100 is charged when the unmanned delivery equipment 100 arrives at the transit station in the present exemplary embodiment, the battery of the unmanned delivery equipment 100 may be charged when the unmanned delivery equipment 100 arrives at the start station or the destination station. In addition, in an exemplary embodiment, the battery of the unmanned delivery equipment 100 may be charged wireles sly or by solar energy. When the battery of the unmanned delivery equipment 100 is charged by the solar energy, the battery may be charged at any time such as when the unmanned delivery equipment 100 is landed at the station, when moving in the means of transportation or when flying.

In a step of S335, it is determined whether a second means of transportation arrives at the transit station. In an exemplary embodiment, the unmanned delivery equipment 100 may wireles sly receive a signal notifying that the second means of transportation arrives at the transit station so that the unmanned delivery equipment 100 may determine that the second means of transportation arrives at the transit station. In a step of S340, when it is determined that the second means of transportation arrives at the transit station in the step of S335, the unmanned delivery equipment 100 may be loaded in the second means of transportation. The unmanned delivery equipment 100 may continuously shoot an identification mark attached to the second means of transportation to displace the unmanned delivery equipment 100 toward the identification mark. The unmanned delivery equipment 100 determines whether the unmanned delivery equipment 100 is disposed in a predetermined distance from the identification mark. When the unmanned delivery equipment 100 is disposed in the predetermined distance from the identification mark, the unmanned delivery equipment 100 may land at the second means of transportation adjacent to the identification mark. After the unmanned delivery equipment 100 is loaded in the second means of transportation, the unmanned delivery equipment 100 may land at second, third, . . . transit stations and may be loaded in third, fourth, . . . means of transportation by repeating the steps of S325 to S340 according to the station route information.

In a step of S350, it is determined whether the unmanned delivery equipment 100 arrives at the destination station. The unmanned delivery equipment 100 may wirelessly receive a signal notifying that the second means of transportation arrives at the destination station from the arriving time providing server so that the unmanned delivery equipment 100 may determine that the unmanned delivery equipment 100 arrives at the destination station. In a step of S355, when it is determined that the unmanned delivery equipment 100 arrives at the destination station, the unmanned delivery equipment 100 may fly to the destination of the delivery. In the present step, similarly to the step of S310, the address of the destination of the delivery may be set as a destination in the navigation module 210 so that the unmanned delivery equipment 100 may automatically fly to the destination of the delivery. In an exemplary embodiment, the destination of the delivery may be an address of a pick up place near the destination station as well as an address of a customer finally receiving the product.

1. A method of delivering a product operated by an electronic module in an unmanned delivery equipment, the method comprising:
obtaining, from a delivery server, information of a destination of delivery of the product, a start station, a destination station and a means of transportation to ride at the start station from a delivery server;
controlling the unmanned delivery equipment to fly to the start station;
determining whether the means of transportation arrives at the start station;
loading the unmanned delivery equipment in the means of transportation when the means of transportation arrives at the start station;
determining whether the unmanned delivery equipment arrives at the destination station; and
controlling the unmanned delivery equipment to fly to the destination of delivery when the unmanned delivery equipment arrives at the destination station.

2. The method of claim 1, further comprising:
obtaining, from the delivery server, information of a transit station and a second means of transportation to ride at the transit station from the delivery server;
determining whether the unmanned delivery equipment arrives at the transit station;
landing the unmanned delivery equipment at the transit station when the unmanned delivery equipment arrives at the transit station;
determining whether the second means of transportation arrives at the transit station; and
loading the unmanned delivery equipment in the second means of transportation when the second means of transportation arrives at the transit station.

3. The method of claim 1, wherein the obtaining the information of the destination of delivery of the product, the start station, the destination station and the means of transportation to ride at the start station comprises receiving the information of the destination of delivery of the product, the start station, the destination station and the means of transportation to ride at the start station.

4. The method of claim 2, wherein the information of the destination of delivery comprises an address of the destination of delivery,
wherein the information of the start station and the destination station respectively comprises an address of the start station and an address of the destination station, and
wherein the information of the means of transportation to ride at the start station comprises ID of the means of transportation.

5. The method of claim 2, wherein the information of the transit station and the second means of transportation to ride at the transit station respectively comprises an address of the transit station and ID of the second means of transportation.

6. The method of claim 4, wherein the information of the start station, the destination station and the means of transportation to ride at the start station is determined from station route information generated based on an address of a start point and the address of the destination of delivery.

7. The method of claim 6, wherein the information of the transit station and the second means of transportation to ride at the transit station is determined from the station route information generated based on the address of the start point and the address of the destination of delivery.

8. The method of claim 4, wherein the unmanned delivery equipment comprises a navigator,
wherein the controlling the unmanned delivery equipment to fly to the start station comprises setting the address of the start station as a destination in the navigator so that the unmanned delivery equipment automatically fly to the start station.

9. The method of claim 8, wherein the controlling the unmanned delivery equipment to fly to the start station further comprises determining whether the unmanned delivery equipment arrives at a predetermined place by the address of the start station.

10. The method of claim 9, wherein the determining whether the unmanned delivery equipment arrives at the predetermined place by the address of the start station comprises:
continuously shooting an object which is one of ID and QR code displayed at the start station and an identification mark attached to the start station to displace the unmanned delivery equipment toward the object; and
determining whether the unmanned delivery equipment is disposed in a predetermined distance from the object.

11. The method of claim 10, wherein the controlling the unmanned delivery equipment to fly to the start station comprises landing the unmanned delivery equipment at the start station adjacent to the object when the unmanned delivery equipment arrives at the predetermined place by the address of the start station.

12. The method of claim 1, wherein the determining whether the means of transportation arrives at the start station comprises wirelessly receiving a signal notifying that the means of transportation arrives at the start station from an arriving time providing server.

13. The method of claim 4, wherein the means of transportation comprises RFID tag,
wherein the unmanned delivery equipment comprises RFID reader, and
wherein the determining whether the means of transportation arrives at the start station comprises identifying information of RFID tag of the means of transportation using the RFID reader and comparing the identified information to the ID of the means of the transportation.

14. The method of claim 1, wherein the loading the unmanned delivery equipment in the means of transportation comprises:
continuously shooting an identification mark attached to the means of transportation to displace the unmanned delivery equipment toward the identification mark;
determining whether the unmanned delivery equipment is disposed in a predetermined distance from the identification mark; and
landing the unmanned delivery equipment at the means of transportation displaying the identification mark when the unmanned delivery equipment is disposed in the predetermined distance from the identification mark.

15. (canceled)

16. (canceled)

17. The method of claim 2, wherein the obtaining the information of the transit station and the second means of transportation to ride at the transit station comprises receiving the information of the transit station and the second means of transportation to ride at the transit station.

18. The method of claim 2, wherein the determining whether the unmanned delivery equipment arrives at the transit station comprises wirelessly receiving a signal notifying that the means of transportation arrives at the transit station from an arriving time providing server.

19. The method of claim 2, wherein the landing the unmanned delivery equipment at the transit station comprises:
continuously shooting an object which is one of ID and QR code displayed at the transit station and an identification mark attached to the transit station to displace the unmanned delivery equipment toward the object;
determining whether the unmanned delivery equipment is disposed in a predetermined distance from the object; and
landing the unmanned delivery equipment at the transit station adjacent to the object when the unmanned delivery equipment is disposed in the predetermined distance from the object.

20. (canceled)

21. The method of claim 2, wherein the loading the unmanned delivery equipment in the second means of transportation comprises:
continuously shooting an identification mark attached to the second means of transportation to displace the unmanned delivery equipment toward the identification mark;
determining whether the unmanned delivery equipment is disposed in a predetermined distance from the identification mark; and
landing the unmanned delivery equipment at the second means of transportation displaying the identification mark when the unmanned delivery equipment is disposed in the predetermined distance from the identification mark.

22. A computer readable storage medium storing a program, the program comprising commands, the commands operating the method of claim 1 when the commands are executed by the program.

23. The method of claim 1, wherein the means of transportation comprises one of public transportation, a private means of transportation for the unmanned delivery equipment, a freight car, a ship, an unmanned means of transportation and an unmanned equipment.
